(19) United States
(12) Patent Application Publication
(10) Pub. No.: US 2023/0318238 A1
(43) Pub. Date: Oct. 5, 2023

(54) ELECTRONIC DEVICE, ELECTRONIC KEYBOARD INSTRUMENT, AND MANUFACTURING METHOD OF ELECTRONIC DEVICE

(71) Applicant: CASIO COMPUTER CO., LTD., Tokyo (JP)

(72) Inventors: Kouji OSHIMA, Tokyo (JP); Naoto IMAMURA, Tokyo (JP); Yuuki NAKAJIMA, Tokyo (JP); Mari NAKAJIMA, Tokyo (JP); Ryohei KOBAYASHI, Tokyo (JP); Shingo FUKUSHIMA, Tokyo (JP)

(73) Assignee: CASIO COMPUTER CO., LTD., Tokyo (JP)

(21) Appl. No.: 18/206,815

(22) Filed: Jun. 7, 2023

Related U.S. Application Data
(63) Continuation of application No. PCT/JP2021/042336, filed on Nov. 17, 2021.

(30) Foreign Application Priority Data
Dec. 10, 2020 (JP) 2020-204675
Feb. 25, 2021 (JP) 2021-028395

(51) Int. Cl. H01R 24/00; H01R 24/68; G10H 1/32

(52) U.S. Cl. CPC H01R 24/005; H01R 24/68; G10H 1/32; H01R 2201/00; G10H 2230/065

(57) ABSTRACT

An electronic device includes an attaching member including a first attaching member having a first male portion protruding in a first direction from an outer circumference of the first attaching member, and a second attaching member having a first female portion corresponding to the first male portion, and an attached member to which the attaching member is attached. The attaching member includes either one of a second male portion extending in a second direction different from the first direction and a second female portion corresponding to the second male portion. The attached member includes the other of the second male portion and the second female portion.

### CROSS-REFERENCE TO RELATED APPLICATIONS

The present application is a continuation application of PCT/JP2021/042336 that claims priority to Japanese Patent Application No. 2020-204675 filed on Dec. 10, 2020 and Japanese Patent Application No. 2021-028395 filed on Feb. 25, 2021, the entire contents thereof are incorporated herein by reference.

### TECHNICAL FIELD

The present disclosure relates to an electronic device, an electronic keyboard instrument, and a manufacturing method of an electronic device.

### BACKGROUND ART

In the related art, terminal boxes, panels, and the like manufactured by injection molding of resin have been disclosed for electronic devices and electronic keyboard instruments. For example, an electrical junction box used in an electronic device which is disclosed in Patent Literature 1 includes a box body having a perforated plate protruding from a side plate and having an insertion hole, and a cover with a positioning pin inserted into the insertion hole, and when the cover is attached to the box body, the positioning pin is inserted into the insertion hole to correct warping of the side plate. An insertion direction of the positioning pin is parallel to a flat surface of the side plate.

### CITATION LIST

### Patent Literature

Patent Literature 1: JPH11-299053A

### SUMMARY OF INVENTION

An electronic device according to an embodiment of the present disclosure includes: an attaching member including a first attaching member having a first male portion protruding in a first direction from an outer circumference of the first attaching member and a second attaching member having a first female portion corresponding to the first male portion; and an attached member to which the attaching member is attached. The attaching member includes either one of a second male portion extending in a second direction different from the first direction and a second female portion corresponding to the second male portion, and the attached member includes the other of the second male portion and the second female portion.

An electronic keyboard instrument of the present disclosure includes the above-described electronic device and a keyboard.

A manufacturing method of an electronic device of the present disclosure includes: fitting a first male portion protruding in a first direction from an outer circumference of a first attaching member into a first female portion of a second attaching member; fitting, into a second female portion included in an attached member, a second male portion provided on either one of the first attaching member and the second attaching member and extending in a second direction different from the first direction, or fitting the second male portion included in the attached member and extending in the second direction different from the first direction into the second female portion provided on either one of the first attaching member and the second attaching member.

According to the present disclosure, an electronic device, an electronic keyboard instrument, and a manufacturing method of an electronic device in which an attaching member is satisfactorily fixed to an attached member can be provided.

### BRIEF DESCRIPTION OF DRAWINGS

FIG. 1 is a perspective view of an electronic keyboard instrument according to an embodiment of the present disclosure;

FIG. 2 is an exploded perspective view showing a top member and an instrument case separated from each other of the electronic keyboard instrument according to the embodiment of the present disclosure;

FIG. 3 is a perspective view of the top member of the electronic keyboard instrument according to the embodiment of the present disclosure, viewed from a lower side;

FIG. 4 is a perspective view showing a state in which the top member of the electronic keyboard instrument according to the embodiment of the present disclosure is separated into a console panel and a speaker cover, viewed from a lower side;

FIG. 5 is an enlarged perspective view of a left end portion showing the state in which the top member of the electronic keyboard instrument according to the embodiment of the present disclosure is separated into the console panel and the speaker cover, viewed from a lower front side;

FIG. 6 is an enlarged perspective view of a left end portion of the console panel of the electronic keyboard instrument according to the embodiment of the present disclosure, viewed from a lower back side;

FIG. 7 is a perspective view showing the state in which the top member of the electronic keyboard instrument according to the embodiment of the present disclosure is separated into the console panel and the speaker cover, viewed from a top side;

FIG. 8 is an enlarged perspective view of a Q4 part in FIG. 7, viewed from an upper side, around a volume knob of the console panel of the electronic keyboard instrument according to the embodiment of the present disclosure;

FIG. 9 is a cross-sectional view corresponding to an IX-IX cross section of FIG. 8 in the top member of the electronic keyboard instrument according to the embodiment of the present disclosure;

FIG. 10 is a cross-sectional view corresponding to an X-X cross section of FIG. 8 in the top member of the electronic keyboard instrument according to the embodiment of the present disclosure;

FIG. 11A and FIG. 11B show a cross section corresponding to an XI-XI cross section of FIG. 1, showing a manufacturing method of an electronic keyboard instrument according to an embodiment of the present disclosure, FIG. 11A shows a state before the console panel and the speaker cover are attached to each other, and FIG. 11B shows a state after the console panel and the speaker cover are attached to each other;

FIG. 12A and FIG. 12B show a cross section corresponding to the XI-XI cross section of FIG. 1 relating to the top member and an upper case, showing the manufacturing method of the electronic keyboard instrument according to the embodiment of the present disclosure, FIG. 12A shows a state before the top member and the upper case are attached to each other, and FIG. 12B shows a state after the top member and the upper case are attached to each other; and

FIG. 13 is a cross-sectional view showing a back side of the XI-XI cross section of FIG. 1 of the electronic keyboard instrument according to the embodiment of the present disclosure.

### DESCRIPTION OF EMBODIMENTS

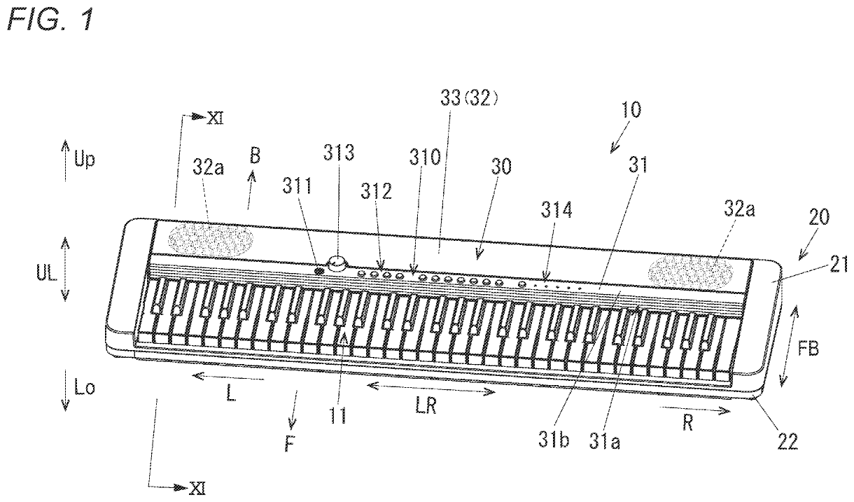

Embodiments of the present disclosure will be described below with reference to the drawings. An electronic keyboard instrument 10 as an electronic device shown in FIG. 1 includes a 61-key keyboard 11 and an instrument case 20. In the following description, a front side of the keyboard 11 in a front-back direction FB is defined as a front side F, a back side of the key in the front-back direction FB is defined as a back side B, a left side of the keyboard 11 is defined as a left side L, and a right side thereof is defined as a right side R. A key arrangement direction LR of the keyboard 11 is a left-right direction. Also, an upper side of an upper-lower direction UL of the electronic keyboard instrument 10 is defined as an upper side Up and a lower side thereof is defined as a lower side Lo.

The instrument case 20 (attached member) is in a shape of a substantially long rectangular plate with the left-right direction being a longitudinal direction, and includes an upper case 21 (attached member) and a lower case 22. The upper case 21 and the lower case 22 are each manufactured by injection molding of a resin material and connected by bolts (not shown). A board, a battery as a power supply, and the like are accommodated inside the instrument case 20.

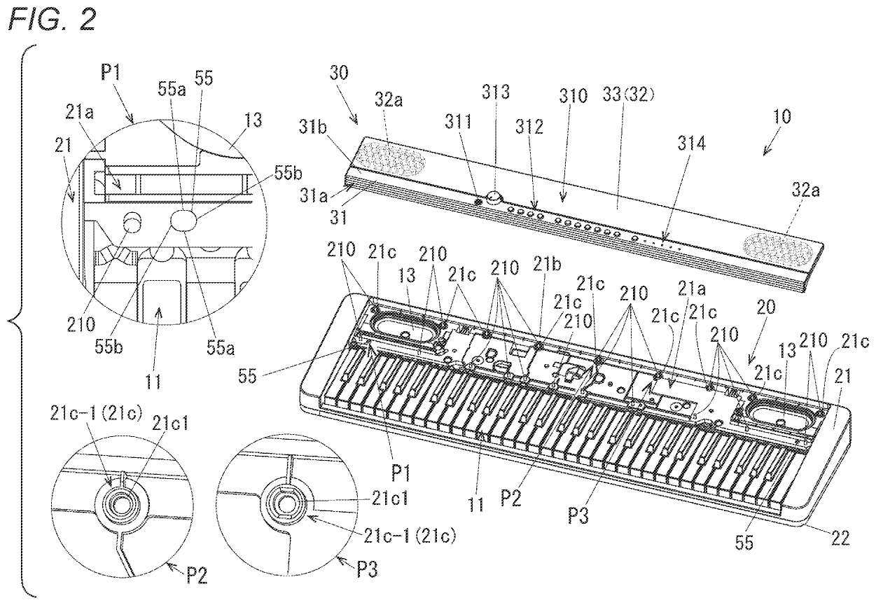

As also shown in FIGS. 1 and 2, a top member 30 (attaching member) is disposed on the back side B of the keyboard 11. The top member 30 has a console panel 31 (first attaching member) and a speaker cover 32 (second attaching member) which are both manufactured by injection molding of a resin material. The console panel 31 is elongated in the key arrangement direction LR, and is provided with an operation unit 310 having a power button 311, an operation button 312, a volume knob 313, and an LED display unit 314 for displaying an operation state. A fabric 33 is wrapped on the speaker cover 32.

As shown in FIG. 2, the top member 30 is attached to a substantially concave top member attaching portion 21a on the back side B of the top of the upper case 21. In the top member attaching portion 21a, pin insertion holes 55 (second female portion) are provided on both ends in the key arrangement direction LR on the front side F of the top member attaching portion 21a. The pin insertion holes 55 are elongated holes slightly elongated in the key arrangement direction LR. As shown in an enlarged view of a P1 part in FIG. 2, which is an enlarged view of the periphery of the pin insertion hole 55 on the left side, the pin insertion hole 55 has straight portions 55a provided parallel to the front side F and the back side B, and arcuate portions 55b connecting the two straight portions 55a at both ends. The pin insertion hole 55 is provided at a position corresponding to a pin 51 (second male portion), which will be described later. The top member attaching portion 21a has a wall 21b erected on the left, right, and back side B edge portions.

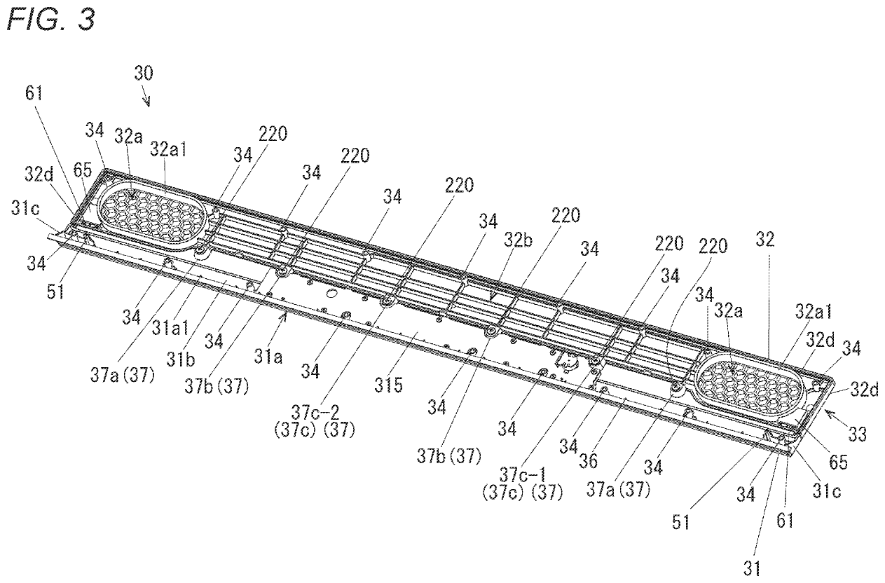

As shown in FIG. 3, a board 315 is provided on an inner surface of the top member 30 corresponding to the operation unit 310. The board 315 is provided across the console panel 31 and the speaker cover 32 in the front-back direction FB. A plurality of bosses 34 having female screw portions for fixing the top member 30 to the upper case 21 with bolts 210 (see FIG. 2) are provided in the vicinity of edge portions of the front side F and the back side B of the top member 30 (that is, the console panel 31 and the speaker cover 32).

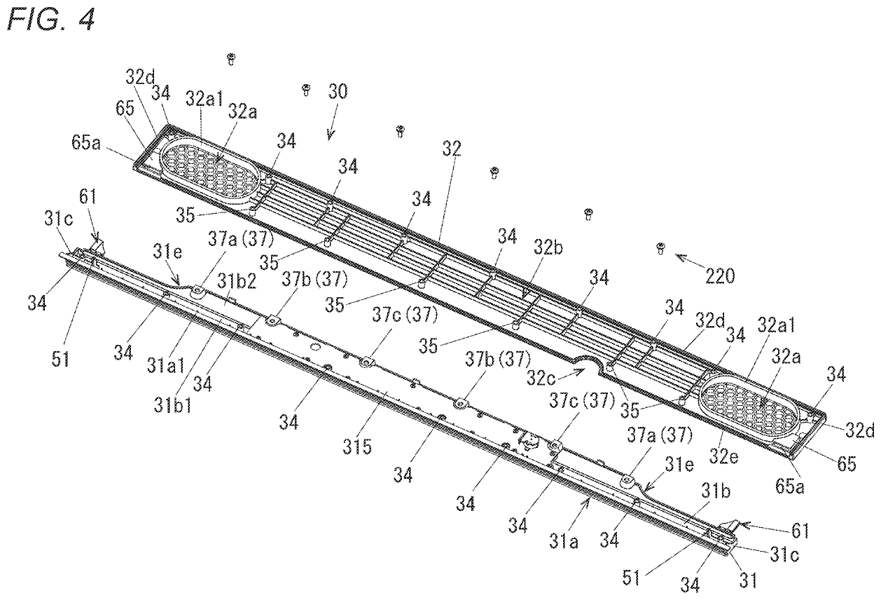

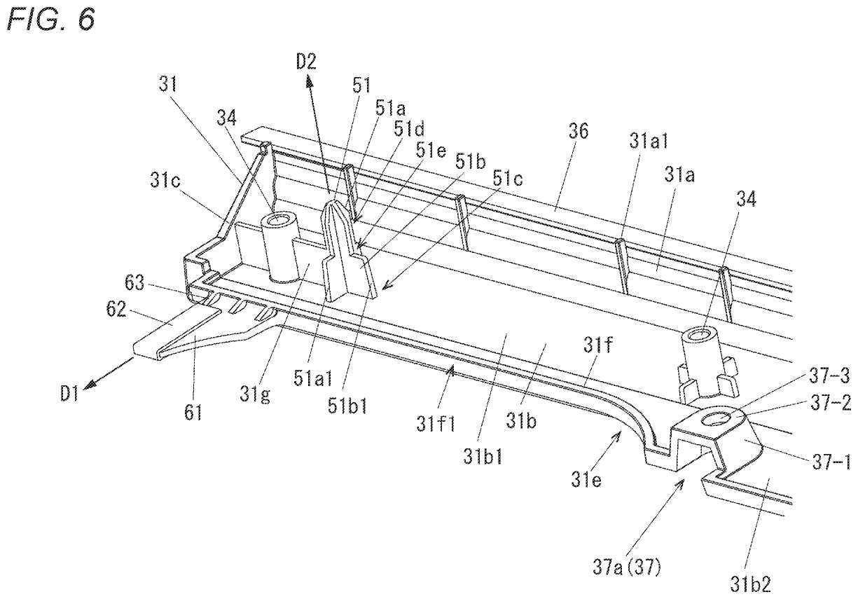

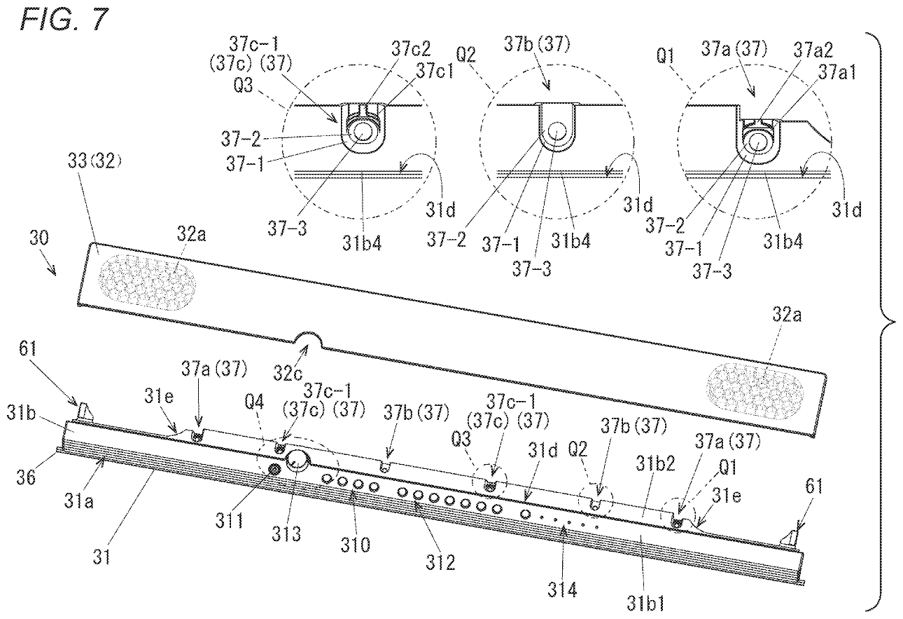

As also shown in FIGS. 3 and 7, the console panel 31 includes a front plate 31a disposed on the front side F of the electronic keyboard instrument 10, and an upper plate 31b on which the operation unit 310 is provided. The front plate 31a and the upper plate 31b are connected so as to be substantially perpendicular to each other when viewed from the side in the key arrangement direction LR. As shown in FIGS. 3 and 4, triangular rib-shaped side plates 31c connected to the front plate 31a and the upper plate 31b are provided at both ends of the console panel 31 in the key arrangement direction LR. An outer surface of the front plate 31a is provided with a concave-convex surface extending in the key arrangement direction LR. As also shown in FIG. 6, a plurality of quadrangular prism-shaped ribs 31a1 are provided on an inner surface of the front plate 31a. A felt member 36 disposed between an upper surface of the keyboard 11 and a lower end of the front plate 31a extends in the key arrangement direction LR.

As shown in FIGS. 4 and 7, the upper plate 31b of the console panel 31 includes an upper plate main body portion 31b1 provided with the operation unit 310 and exposed to the outside, and an upper plate connection portion 31b2 connected to the upper plate main body portion 31b1 via a stepped portion 31d. An upper surface of the upper plate connection portion 31b2 is located on the lower side Lo of the upper surface of the upper plate main body portion 31b1. Both ends of the upper plate connection portion 31b2 in the key arrangement direction LR are provided with arcuate portions 31e following arcuate edge portions of speaker hole portions 32a of the speaker cover 32, which will be described later.

In the console panel 31, the pins 51 (second male portions) protruding in a second direction D2 different from a first direction D1 which will be described later are provided on an inner surface of the upper plate main body portion 31b1 in the vicinity of both ends in the key arrangement direction LR. As shown in FIG. 6, the pin 51 is provided in a substantially cross shape in which a front-back plate 51a and a left-right plate 51b intersect each other at a right angle. Therefore, an edge surface 51a1 of the front-back plate 51a is disposed to face the front side F and the back side B. On the other hand, an edge surface 51b1 of the left-right plate 51b faces the right side R in the pin 51 on the left side L shown in FIG. 6, and faces the left side L in the pin 51 on the right side R. A rib 31g for reinforcement is connected to an inner surface of the side plate 31c via the boss 34 in a base portion 51c on an outer side (a side opposite to the edge surface 51b1) of the left-right plate 51b. The front-back plate 51a and the left-right plate 51b have a tapered tip portion 51d, the base portion 51c is wider than the tip portion 51d, and the tip portion 51d and the base portion 51c are connected by a stepped portion 51e.

An edge wall 31f is provided at an edge portion of the back side B of the upper plate connection portion 31b2. In the vicinity of both ends of the edge wall 31f in the key arrangement direction LR (that is, in the vicinity of both ends of the console panel 31), a wing member 61 (also referred to as a male portion (first male portion), protruding piece, or fin) protrudes in the first direction D1 from an edge surface 31f1 of the edge wall 31f (that is, an outer circumference of the console panel 31). The wing member 61 has a substantially triangular plate shape with an oblique side facing inward (right side R for the left wing member 61, left side L for right wing member 61), and is provided such that a flat surface faces the upper-lower direction UL. A felt member 62, which is a fabric member covering via a tip portion of the wing member 61, is adhered to the wing member 61 from a surface at the upper side Up to a flat surface which is a surface at the lower side Lo of the wing member 61. At a base portion of the wing member 61, substantially triangular ribs 63 connecting the edge surface 31f1 and the surface at the lower side Lo of the wing member 61 are provided at three locations in the key arrangement direction LR. The wing member 61 is provided in a tapered shape such that a plate thickness gradually increases from the tip to the base portion. In this manner, the pin 51 and the wing member 61 extend in directions substantially perpendicular to each other. In other words, the first direction D1 and the second direction D2 are perpendicular to each other.

As shown in FIG. 7, a plurality of boss disposing portions 37 are provided on the upper plate connection portion 31b2 of the console panel 31. Bosses 35 provided on the speaker cover 32 which will be described later are positioned in the boss disposing portions 37. The boss disposing portions 37 include a first boss disposing portion 37a, a second boss disposing portion 37b, and a third boss disposing portion 37c which have different internal shapes. From the left side L of FIG. 7, the boss disposing portions 37 are arranged in the key arrangement direction LR in an order of the first boss disposing portion 37a, the third boss disposing portion 37c, the second boss disposing portion 37b, the third boss disposing portion 37c, the second boss disposing portion 37b, and the first boss disposing portion 37a.

As shown in enlarged views (Q1 to Q3) of FIGS. 6 and 7, each boss disposing portion 37 has a substantially U-shaped wall 37-1 whose back side is open in plan view, and a bottom plate 37-2 connected to the U-shaped wall 37-1 at the lower side Lo. The U-shaped wall 37-1 is connected to the edge wall 31f. The U-shaped wall 37-1 is provided in a tapered shape such that a width gradually narrows from the upper side Up toward the lower side Lo. The bottom plate 37-2 is provided with a hole portion 37-3 through which a bolt 220 (see FIG. 4) is inserted. As shown in the enlarged views of the Q1 part and the Q3 part in FIG. 7, arc-shaped restricting walls 37a1 and 37c1 erected from surfaces at the upper side Up of the bottom plates 37-2 are provided inside the concave first boss disposing portion 37a and third boss disposing portion 37c. The restricting walls 37a1 and 37c1 are arcuately convex toward the back side B, and ribs 37a2 and 37c2 are provided substantially in the center. A length of the rib 37a2 of the first boss disposing portion 37a in the front-back direction FB is longer than the rib 37c2 of the third boss disposing portion 37c. A surface on the upper side Up of the bottom plate 37-2 of the second boss disposing portion 37b is flat.

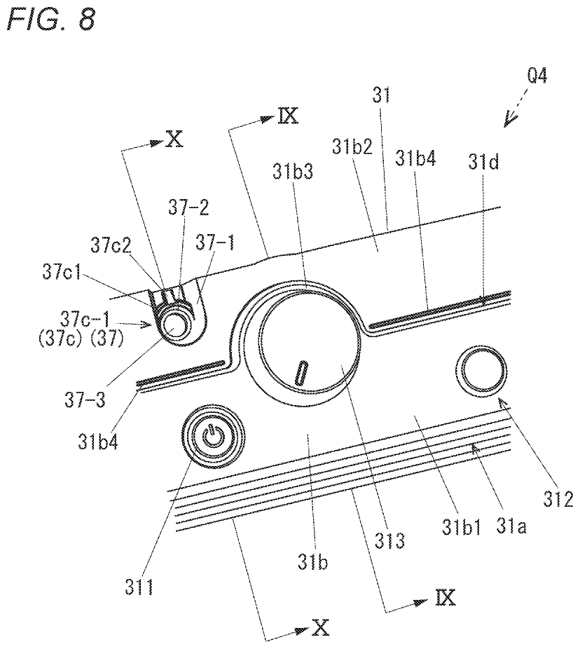

Among the boss disposing portions 37, the first boss disposing portion 37a and the third boss disposing portion 37c are provided such that a diameter in the front-back direction FB of the bottom plates 37-2 is slightly larger than a diameter of the boss 35 of the speaker cover 32, and substantially coincident with each other. On the other hand, in the third boss disposing portions 37c, a bottom plate 37-2 of a third boss disposing portion 37c-1 near the volume knob 313 is circular as shown in FIG. 8. That is, a diameter of the bottom plate 37-2 of the third boss disposing portion 37c-1 near the volume knob 313 is set to be slightly larger than the diameter of the boss 35 of the speaker cover 32, and the diameters are substantially the same. On the other hand, the boss disposing portions 37 other than the third boss disposing portion 37c-1 are provided to be larger than the bosses 35 in the key arrangement direction LR so that the bosses 35 escape at the time of positioning.

That is, when the bosses 35 are disposed in the boss disposing portions 37, the bosses 35 are positioned by the first boss disposing portions 37a and the third boss disposing portions 37c in the front-back direction FB, and positioned only by the third boss disposing portion 37c-1 near the volume knob 313 in the key arrangement direction LR. Therefore, by the first boss disposing portions 37a and the third boss disposing portions 37c which are disposed at a predetermined interval, a gap between a front edge of the speaker cover 32 (front wall 32e which will be described later) and the stepped portion 31d of the console panel 31 can be made uniform. The gaps between the front edge of the speaker cover 32 and the stepped portion 31d of the console panel 31 at both ends of the console panel 31 in the key arrangement direction LR (left and right outside of the boss disposing portions 37a) are adjusted by fitting the pins 51 to the pin insertion holes 55, which will be described later.

The positioning of the console panel 31 and the speaker cover 32 in the key arrangement direction LR is determined only by the third boss disposing portion 37c-1 near the volume knob 313, so that a gap between an annular rib portion 31b3, which will be described later, around the volume knob 313 and a notch portion 32c of the speaker cover 32 corresponding to the annular rib portion 31b3 is adjusted to be uniform. In particular, since the speaker cover 32 is provided with the fabric 33, unevenness in the gap between the annular rib portion 31b3 and the notch portion 32c is easily noticeable, and thus, a configuration in which the speaker cover 32 is positioned with respect to the console panel 31 in the front-back direction FB and the key arrangement direction LR by the third boss disposing portion 37c-1 near the volume knob 313 is preferable.

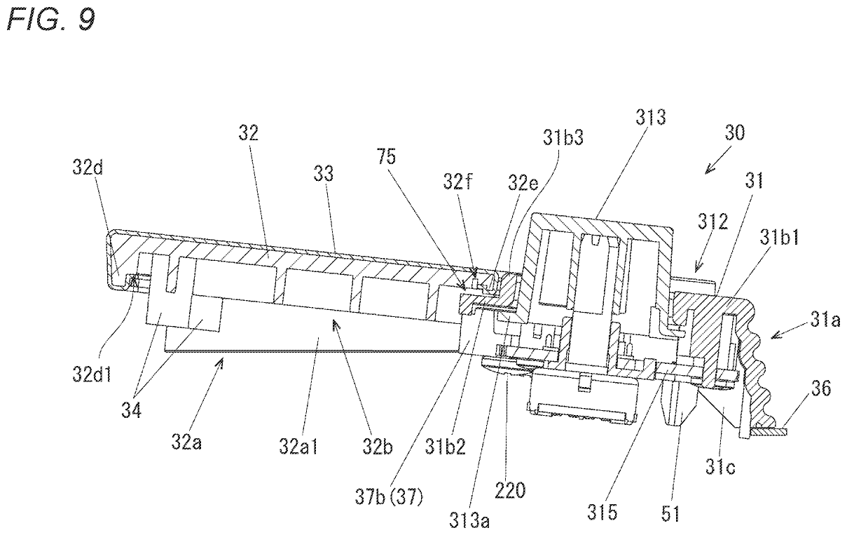

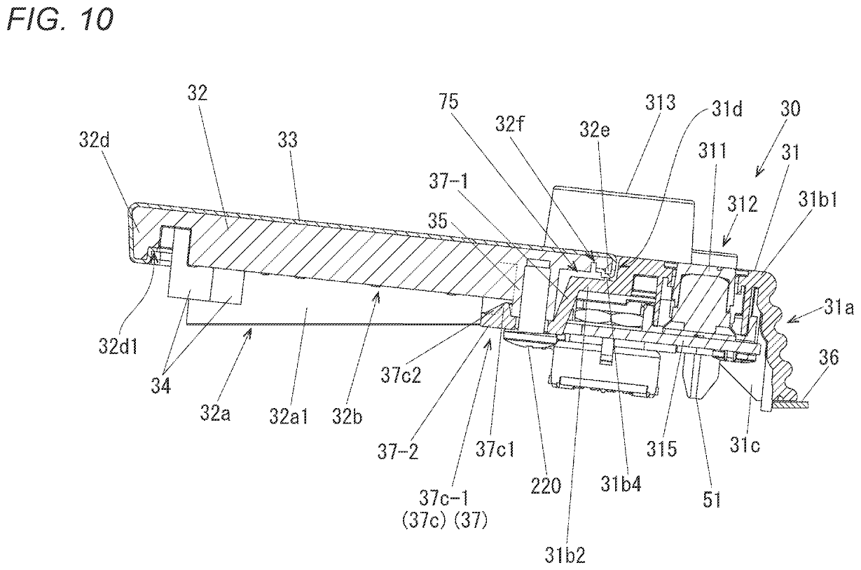

As shown in FIGS. 8 and 9, the annular rib portion 31b3 formed in an arc shape is provided on an upper surface of the upper plate connection portion 31b2 on an outer circumference of the volume knob 313. Further, as shown in FIGS. 8 and 10, a rib portion 31b4 extending in the key arrangement direction LR is provided in the vicinity of the stepped portion 31d on the upper surface of the upper plate connection portion 31b2. The rib portion 31b4 is not provided on an outer circumferential side of the annular rib portion 31b3 (see also FIG. 9).

As shown in FIG. 10, the rib portion 31b4 can receive the surface at the lower side Lo of the front wall 32e of the speaker cover 32. Since the rib portion 31b4 is not provided on an outer circumference of the annular rib portion 31b3, even if the speaker cover 32 is pressed from above, the upper plate connection portion 31b2 will not bend. Therefore, the upper plate connection portion 31b2 does not press a flange portion 313a (see FIG. 9) of the volume knob 313 to prevent the volume knob 313 from turning. Due to the annular rib portion 31b3, the fabric 33 is less likely to be entangled when the volume knob 313 disposed adjacent to an overlapping disposing portion 75, which will be described later, is rotated.

As shown in FIGS. 1 and 2, on the back side B of the console panel 31, the flat speaker cover 32 having a width substantially equal to that of the console panel 31 in the key arrangement direction LR is provided. The speaker cover 32 has, as shown in FIG. 2, speaker hole portions 32a having a plurality of holes and corresponding to the speakers 13 disposed in the vicinity of both ends of the upper surface of the upper case 21.

As shown in FIGS. 3 and 4, the speaker hole portion 32a is provided with an annular wall 32a1 on an outer circumference thereof. The wall 32a1 has a long rectangular shape with rounded corners having semicircular ends. As shown in FIG. 4, the plurality of bosses 35 for connection with the console panel 31 are erected from an inner surface at the front side F of the speaker cover 32. The bosses 35 are provided with female screw portions and are disposed along the key arrangement direction LR corresponding to the boss disposing portions 37.

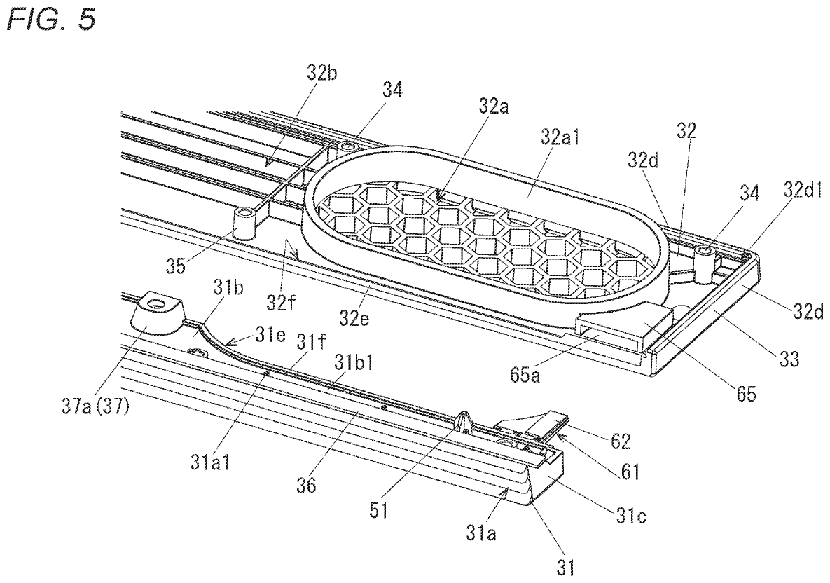

A wall 32d is provided on the back side B and left and right side edges of the speaker cover 32 so as to protrude to the lower side Lo. The front wall 32e is provided on the edge portion at the front side F of the speaker cover 32 so as to connect the ends of the wall 32d on the left and right side edges. As shown in FIG. 5, the wall 32d is provided with a stepped portion 32d1 inside. The front wall 32e is sufficiently lower in height than the wall 32d. On the inner surface (surface of the lower side Lo) of the speaker cover 32 in the vicinity of the inside of the front wall 32e serving as an edge portion facing the console panel 31, a groove 32f linearly extending in the key arrangement direction LR is provided along an edge portion which is the front wall 32e (see also FIGS. 9 and 10). Here, in a manufacturing process of wrapping the fabric 33 around the speaker cover 32, the fabric 33 wrapped around the speaker cover 32 is cut with a cutter knife or the like, and in the higher wall 32d, the fabric can be cut along an edge line of the stepped portion 32d1 of the wall 32d. In the front wall 32e having a lower height, the fabric 33 can be cut by inserting a blade such as a cutter knife for cutting the fabric 33 into the concave groove 32f.

The wall 32a1 of the speaker hole portion 32a, the wall 32d erected on the outer circumference of the speaker cover 32, and bosses 34 and 35 to which the bolts 210 and 220 are screwed are appropriately connected to ribs 32b that extend in the front-back direction FB and the key arrangement direction LR and are arranged in a grid pattern. As shown in FIG. 7, the semicircular notch portion 32c is provided at a portion of the speaker cover 32 corresponding to the volume knob 313 (annular rib portion 31b3).

As shown in FIG. 4, inserted portions 65 are provided in the vicinity of both ends at the inner surface of the speaker cover 32. As shown in FIG. 5, the inserted portion 65 is provided at a corner portion on the front side F of the speaker cover 32 which is a position corresponding to the wing member 61. The inserted portion 65 has a long rectangular box shape elongated in the key arrangement direction LR, and the front side F thereof is provided with a flat hole portion 65a (also referred to as a first female portion, a protruding piece insertion hole, or an elongated hole) opening in a rectangular shape long in the key arrangement direction LR. The inserted portion 65 is connected to the wall 32a1 of the speaker hole portion 32a, and this connection portion is shaped like a concave arc following the wall 32a1.

That is, the electronic device according to the embodiment of the present disclosure includes: the attaching member (top member 30) including the first attaching member (console panel 31) having the first male portion (wing member 61) protruding from the outer circumference in the first direction D1, and the second attaching member (speaker cover 32) having the first female portion (flat hole portion 65a) to which the first male portion is fitted; and the attached member (instrument case 20, upper case 21) to which the attaching member is attached. The attaching member includes either one of the second male portion (pin 51) extending in the second direction D2 different from the first direction D1 and the second female portion (pin insertion hole 55) corresponding to the second male portion, and the attached member includes the other of the second male portion and the second female portion. The first male portion protruding in the first direction D1 and the first female portion suppress bending in the upper-lower direction, a gap between the first attaching member and the second attaching member is adjusted by inserting the second male portion (pin 51) extending in the second direction D2 into the second female portion (pin insertion hole 55), and the first attaching member, the second attaching member, and the attached member can be satisfactorily fixed to each other.

More specifically, the first boss disposing portions 37a of the top member 30 in the key arrangement direction LR are positioned in the key arrangement direction LR and the front-back direction FB by the shape of the bottom plates 37-2 in the boss disposing portions 37 described above, and are fixed by the bolts 220 to be positioned in the upper-lower direction UL as well. On the other hand, at both ends of the top member 30, the boss disposing portions 37 cannot be provided because no sufficient space for the speakers 13 to be disposed is present. However, positioning in the key arrangement direction LR, the front-back direction FB, and the upper-lower direction UL is achieved by the wing members 61, the flat hole portions 65a, the pins 51, and the pin insertion holes 55. In this manner, the first attaching member and the second attaching member, and the attaching member and the attached member can be satisfactorily fixed to each other even in a portion where space is limited.

The first male portion includes a wide protruding piece (wing member 61) protruding in the first direction D1, and the protruding piece is longer in a width direction (key arrangement direction LR) than in a thickness direction (plate thickness of the wing member 61). The first female portion into which the protruding piece is inserted includes an elongated hole whose length in the width direction (width direction of the flat hole portion 65a, key arrangement direction LR) is longer than a length in the thickness direction (a height direction of the flat hole portion 65a). Accordingly, in a state in which the plate-shaped first attaching member and the plate-shaped second attaching member are combined, even if the first male portion comes into contact with the first female portion in the upper-lower direction and the left-right direction, a strength of the first male portion can be ensured.

Either one of the first attaching member and the second attaching member includes the boss 35 extending in the second direction D2. The other of the first attaching member and the second attaching member includes the boss disposing portion 37. In a state in which the first male portion extending in the first direction D1 and the first female portion are fitted together, the boss 35 extending in the second direction D2 is fixed at the position of the boss disposing portion 37, and then the first attaching member and the second attaching member are attached to the attached member. In the first attaching member and the second attaching member, the boss 35 extending in the second direction D2 is fixed at the position of the boss disposing portion 37 while the first male portion extending in the first direction D1 and the first female portion are fitted together, and thus, the first attaching member and the second attaching member are combined well and have an advantage of being difficult to come off.

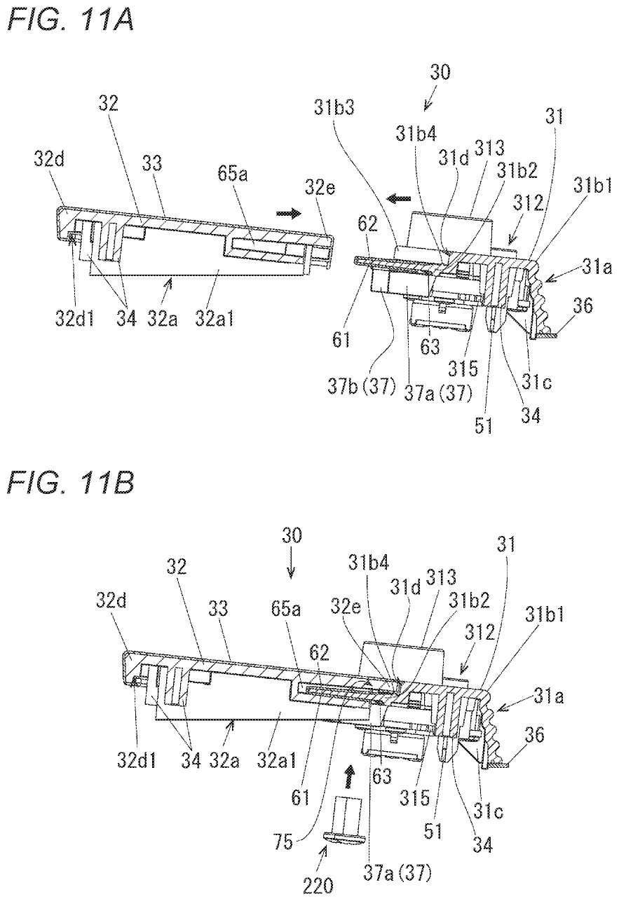

Next, a manufacturing method of an electronic device according to an embodiment of the present disclosure will be described. First, as shown in FIG. 11A and FIG. 11B, in a first step, a first male portion (wing member 61) protruding in a first direction D1 from an outer circumference of a first attaching member (console panel 31) is fitted into a first female portion (flat hole portion 65a) of a second attaching member (speaker cover 32). Since the volume knob 313 (convex portion) is provided on a first attaching member side and the notch portion 32c (recessed portion) is provided on a second attaching member side, the first attaching member and the second attaching member can be easily fitted. The boss 35 provided closest to the notch portion 32c has a function of determining the positions of the first attaching member and the second attaching member.

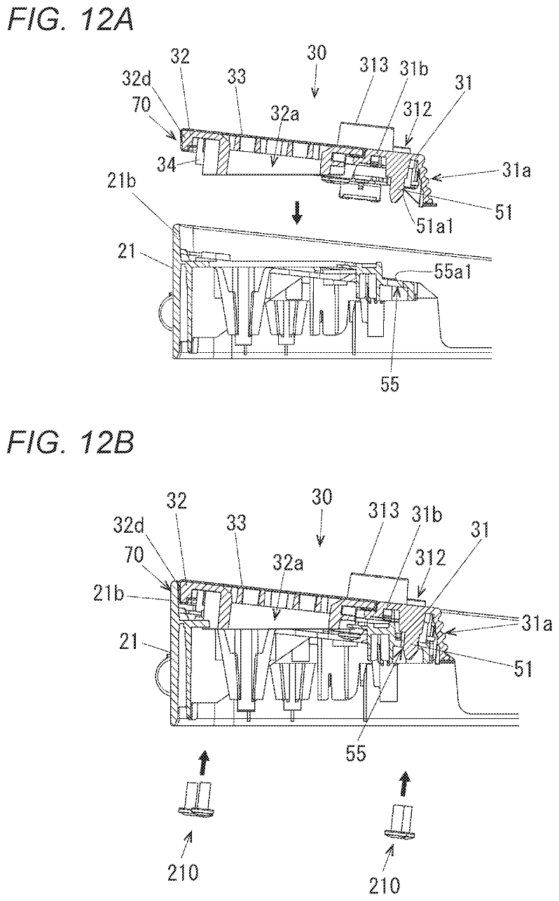

Next, as shown in FIG. 12A and FIG. 12B, in a second step, a second male portion (pin 51) provided on either one of the first attaching member and the second attaching member and extending in a second direction D2 different from the first direction D1 fits into a second female portion (pin insertion hole 55) included in an attached member (upper case 21) (a first embodiment of the second step), and alternatively, the second male portion included in the attached member and extending in the second direction different from the first direction is fitted into the second female portion provided on either one of the first attaching member and the second attaching member (a second embodiment of the second step). Accordingly, an attaching member including the first attaching member and the second attaching member is attached to the attached member, and thus, the respective members can be satisfactorily fixed to each other. Therefore, even if assembly work is performed manually, it is possible to manufacture an electronic device in which the gap between the first attaching member and the second attaching member is satisfactorily adjusted.

Then, in the second step, when the second male portion is fitted into the second female portion, a wall surface sliding portion 70 provided on either one of the first attaching member and the second attaching member comes into contact with the wall 21b included in the attached member. Then, the gap between the first attaching member and the second attaching member (the gap between the front edge of the speaker cover 32 and the stepped portion 31d of the console panel 31) is adjusted to be narrower after the wall surface sliding portion 70 comes into contact with the wall 21b than before the wall surface sliding portion 70 comes into contact with the wall 21b (that is, a state in FIG. 12A). In the present embodiment, the first attaching member and the second attaching member are not fixed at both ends. Therefore, the gap between the first attaching member and the second attaching member at both ends tends to be larger or smaller in the front-back direction of the keys than the gaps at portions other than both ends. However, by adopting such a manufacturing method, it is possible to manufacture an electronic device in which the gap between the first attaching member and the second attaching member is satisfactorily adjusted by the wall surface sliding portion 70. That is, it is possible to provide an electronic device with a good appearance.

A manufacturing method of the electronic keyboard instrument 10 as an electronic device is specifically as follows. When combining the console panel 31 and the speaker cover 32, the wing member 61 is inserted and fitted into the flat hole portion 65a of the inserted portion 65, as shown in FIG. 11A. The wing member 61 is pressed into the flat hole portion 65a by the felt member 62 and the tapered shape. Accordingly, the wing member 61 abuts against the flat hole portion 65a in a direction perpendicular to the flat surface. On the other hand, the wing member 61 has a predetermined clearance with respect to the key arrangement direction LR of the flat hole portion 65a. Therefore, the wing member 61 is positioned in the upper-lower direction UL of the flat hole portion 65a.

Here, the enlarged views of the Q1 part and the Q3 part in FIG. 7 and FIG. 10 are referred to. When combining the console panel 31 and the speaker cover 32, the boss 35 is accommodated in the boss disposing portion 37. In this case, the bosses 35 disposed in the first boss disposing portion 37a and the third boss disposing portion 37c abut against the bosses 35 in the front-back direction FB by the restricting walls 37a1 and 37c1 and a lower end of the U-shaped wall 37-1. In this manner, the bosses 35 are positioned in the front-back direction FB. The positions of the bosses 35 in the key arrangement direction LR are approximately determined by the wall of the U-shaped wall 37-1 in the key arrangement direction LR. By the bottom plate 37-2 of the third boss disposing portion 37c-1 in the vicinity of the volume knob 313, the boss 35 corresponding to the third boss disposing portion 37c-1 is positioned in the key arrangement direction LR, and the speaker cover 32 is positioned with respect to the console panel 31 in the key arrangement direction LR.

When the bosses 35 are disposed in the boss arrangement portions 37 (the first boss disposing portion 37a and the third boss disposing portion 37c), tip portions of the bosses 35 are slidably guided on inclined surfaces of the ribs 37c2, and thus, the bosses are smoothly arranged between the U-shaped walls 37-1 and the restricting walls 37a1 and 37c1. The bolts 220 are screwed to the bosses 35 disposed on the boss disposing portions 37, and the console panel 31 and the speaker cover 32 are fixed.

When the console panel 31 and the speaker cover 32 are combined, the vicinity of the front side F of the speaker cover 32 including the front wall 32e is disposed on the upper side Up of the upper plate connection portion 31b2 of the console panel 31. As described above, the console panel 31 and the speaker cover 32 have the overlapping disposing portion 75 where one of the console panel 31 and the speaker cover 32 is disposed on the upper side Up and the other is disposed on the lower side. As shown in FIG. 11B, after the console panel 31 and the speaker cover 32 are combined, the bolt 220 is screwed into the female screw portion of the boss 35 via the boss disposing portion 37, and the console panel 31 and the speaker cover 32 are fixed to each other.

As shown in FIG. 12A, the top member 30 including the combined console panel 31 and speaker cover 32 is attached to the upper case 21 of the instrument case 20. In this case, the pin 51 is inserted into the pin insertion hole 55. In the pin 51, the front edge surface 51a1 of the front-back plate 51a of the pin 51 abuts against a plate thickness surface of the straight portion 55a on the front side F of the pin insertion hole 55. Since the flat surfaces in the front-back direction FB can abut with each other in this way, a correction amount of the warping of the console panel 31 can be set more easily than when a round pin and a round hole are engaged.

As shown in FIG. 12B, the wall 32d on the back side B of the speaker cover 32 and the wall 21b on the back side B of the top member attaching portion 21a face each other. The top member 30 has the wall surface sliding portion 70 on the surface facing the upper case 21. Here, the console panel 31 is a member manufactured by injection molding and elongated in the key arrangement direction LR, and may be warped in the direction toward the front side F at both ends and toward the back side B at approximately the center. As a result, gaps may occur between the edge (front wall 32e) of the front side F of the speaker cover 32 and the stepped portions 31d near both ends of the console panel 31. However, the pin 51 is inserted into the pin insertion hole 55, and the warping of the console panel 31 is corrected. When the correction amount is large, the wall 32d and the wall 21b of the wall surface sliding portion 70 slide at approximately the center in the key arrangement direction LR, and the warping of the console panel 31 is corrected by inserting the pin 51 into the pin insertion hole 55 and correcting the warping.

That is, when the pin 51 is inserted into the pin insertion hole 55 and the attaching member (top member 30) is attached to the attached member (upper case 21, instrument case 20), the wall surface sliding portion 70 of the attaching member comes into contact with the attached member, thereby adjusting the gap between the first attaching member and the second attaching member.

Then, as shown in FIG. 12B, the top member 30 is fixed to the upper case 21 by screwing the bolts 210 into the female screw portions of the bosses 34. Here, as shown in FIG. 2, the plurality of bolts 210 on the back side B are screwed through corresponding bolt hole portions 21c on the back side B of the upper case 21 to the female screw portions of the bosses 34 (see FIG. 3 and FIG. 4) on the back side B of the speaker cover 32. The bolt hole portion 21c has a seat surface 21c1 against which a tip portion of the boss 34 abuts. The seat surface 21c1 of the substantially central bolt hole portion 21c among the plurality of bolt hole portions 21c is provided in a substantially circular shape (see the enlarged view of a P2 part in FIG. 2). On the other hand, a length in the key arrangement direction LR of the bolt hole portions 21c other than the substantially central bolt hole portion 21c (typically, the enlarged view of a P3 part is shown in FIG. 2) is larger than a diameter of the boss 34. Therefore, in the key arrangement direction LR, the top member 30 is positioned with respect to the upper case 21 by the seat surface 21c1 of the substantially central bolt hole portion 21c. The bolt hole portions 21c are provided over the key arrangement direction LR of the top member attaching portion 21a of the upper case 21, and thus, the top member 30 can be disposed in the upper case 21 in a well-balanced manner by using the substantially central bolt hole portion 21c as a location for positioning. As described above, the pin insertion hole 55 is provided in an elongated hole shape having the key arrangement direction LR as a long-axis direction, and thus, the pin 51 escapes in the key arrangement direction LR. A length of the seat surface 21c1 of the bolt hole portion 21c in the front-back direction FB is slightly larger than the diameter of the boss 35 and substantially coincident with each other.

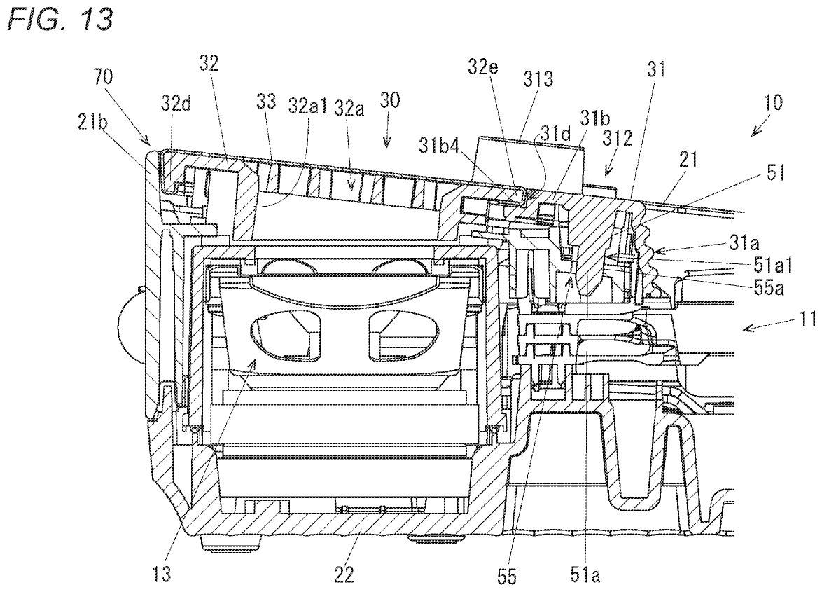

After the top member 30 is assembled to the upper case 21, by using a bolt (not shown) screwed into a female screw portion of a fixing boss 21d erected from the upper case 21 to the lower case 22 to which another member such as the keyboard 11 is assembled, the upper case 21 to which the top member 30 is attached is assembled to the lower case 22 to manufacture the electronic keyboard instrument 10 as shown in FIG. 13.

Since the warping of the console panel 31 is corrected in this way, the gap between the console panel 31 and the speaker cover 32 is made uniform in the key arrangement direction LR, and the upper plate main body portion 31b1 of the console panel 31 and the upper surface of the speaker cover 32 are made into a substantially continuous flat surface, so that the electronic keyboard instrument 10 with a good appearance can be manufactured.

Although the embodiments of the present disclosure have been described above, the present disclosure is not limited to the embodiments and can be implemented with various modifications. For example, in the disposing of the pin 51 and the pin insertion hole 55, the pin insertion hole 55 may be provided in the console panel 31 and the pin 51 may be provided in the upper case 21. Similarly, the wing member 61 and the flat hole portion 65a may be disposed in reverse.

According to the above embodiments of the present disclosure, the electronic keyboard instrument 10 as an electronic device includes the top member 30 as the attaching member including the console panel 31 as the first attaching member having the wing member 61 as the first male portion protruding in the first direction D1 from the outer circumference, and the speaker cover 32 as the second attaching member having the flat hole portion 65a as the first female portion corresponding to the wing member 61; and the instrument case 20 (upper case 21) as the attached member to which the top member 30 is attached. The top member 30 includes either one of the pin 51 as the second male portion extending in the second direction D2 different from the first direction D1 and the pin insertion hole 55 as the second female portion into which the pin 51 is inserted, and the instrument case 20 (upper case 21) includes the other of the pin 51 and the pin insertion hole 55.

Accordingly, the top member 30 is accurately positioned with respect to the upper case 21, and the warping of the console panel 31 is corrected to make the gap between the console panel 31 and the speaker cover 32 appropriate. Therefore, the top member 30 can be satisfactorily fixed to the instrument case 20.

The wing member 61 is a wide protruding piece that protrudes in the first direction D1, and the length in the width direction is larger than the length in the thickness direction. The flat hole portion 65a includes an elongated hole in which the wing member 61 is inserted and whose length in the width direction is larger than the length in the thickness direction. Accordingly, the wing member 61 can be easily disposed on the plate-shaped console panel 31 and the speaker cover 32 while ensuring the strength of the wing member 61.

The top member 30 (speaker cover 32) has the wall surface sliding portion 70 on an outer surface of the wall 32d that faces an inner surface of the wall 21b of the upper case 21. Accordingly, the gap between the console panel 31 and the speaker cover 32 can be adjusted as well as the pin 51 is inserted into the pin insertion hole 55.

The console panel 31 and the speaker cover 32 have the overlapping disposing portion 75 where one of the console panel 31 and the speaker cover 32 overlaps the other, and the console panel 31 is provided with the rib portion 31b4 for receiving the speaker cover 32. Accordingly, even if the speaker cover 32 is pressed, the speaker cover 32 can be received by the rib portion 31b4, and thus, deformation of the speaker cover 32 and the console panel 31 can be reduced.

In the vicinity of the front wall 32e, which is an edge portion corresponding to the console panel 31, the speaker cover 32 has the concave groove 32f provided along the front wall 32e. Accordingly, even if the height of the front wall 32e cannot be increased because the front wall 32e is the edge portion facing the console panel 31, a cutting process after the fabric 33 is wrapped can be efficiently performed in the manufacturing process.

The top member 30 and the instrument case 20 (upper case 21) are provided in an elongated shape, and the pins 51 and the pin insertion holes 55 are provided in the vicinity of both ends in the longitudinal direction. Accordingly, the warping of the console panel 31 of the elongated top member 30 is easily corrected, so that the top member 30 can be appropriately positioned.

The felt member 62, which is a fabric member, is adhered to the flat surface of the wing member 61. Accordingly, even if the electronic device vibrates (for example, while the electronic keyboard instrument 10 is being played), it is possible to reduce occurrence of abnormal noise caused by impingement of the wing member 61 inside the flat hole portion 65a.

The electronic keyboard instrument 10 as an electronic device includes the keyboard 11. Accordingly, it is possible to provide the electronic keyboard instrument 10 in which the top member 30 is satisfactorily fixed to the instrument case 20.

In the manufacturing method of the electronic keyboard instrument 10 as an electronic device, the wing member 61 as the first male portion protruding in the first direction D1 from the outer circumference of the console panel 31 as the first attaching member is fitted into the flat hole portion 65a as the first female portion of the speaker cover 32 as the second attaching member. The pin 51 as the second male portion provided on either one of the console panel 31 and the speaker cover 32 and extending in the second direction D2 different from the first direction D1 is fitted into the pin insertion hole 55 as the second female portion included in the instrument case 20 as the attached member. Accordingly, the gap between the console panel 31 and the speaker cover 32 is adjusted, and the electronic keyboard instrument 10 in which the top member 30 is attached to the instrument case 20 in a favorable manner can be manufactured.

When the pin 51 is fitted into the pin insertion hole 55, the wall surface sliding portion 70 of the top member 30 comes into contact with the wall 21b of the upper case 21. Accordingly, the top member 30 can be attached to the upper case 21 while being properly guided.

The gap between the console panel 31 and the speaker cover 32 is adjusted to be narrower after the wall surface sliding portion 70 comes into contact with the wall 21b than before the wall surface sliding portion 70 comes into contact with the wall 21b. Accordingly, even if the console panel 31 is manufactured by injection molding so as to warp in a bow shape when viewed from above, the gap between the console panel 31 and the speaker cover 32 is made uniform from the central portion to the left and right ends, so that the electronic keyboard instrument 10 with a good appearance can be manufactured.

The several embodiments of the present disclosure have been described, these embodiments have been presented by examples and are not intended to limit the scope of the disclosure. These novel embodiments can be embodied in various other forms, and various omissions, replacements, and modifications can be made without departing from the scope of the disclosure. These embodiments and modifications thereof are included in the scope and gist of the disclosure, and are included in the scope of the disclosure described in the claims and equivalents thereof.

What is claimed is:

1. An electronic device, comprising:
an attaching member including a first attaching member having a first male portion protruding in a first direction from an outer circumference of the first attaching member, and a second attaching member having a first female portion corresponding to the first male portion; and
an attached member to which the attaching member is attached, wherein
the attaching member includes either one of a second male portion extending in a second direction different from the first direction and a second female portion corresponding to the second male portion, and
the attached member includes the other of the second male portion and the second female portion.

2. The electronic device according to claim 1, wherein
the first male portion includes a wide protruding piece that protrudes in the first direction and has a length in a width direction larger than a length in a thickness direction, and
the first female portion includes an elongated hole into which the protruding piece is inserted and which has a length in the width direction larger than a length in the thickness direction.

3. The electronic device according to claim 1, wherein
the attaching member is configured to include a wall surface sliding portion on a surface facing the attached member in a state in which the attaching member is attached to the attached member.

4. The electronic device according to claim 1, wherein
the first attaching member and the second attaching member further have an overlapping disposing portion in which either one of the first attaching member and the second attaching member overlaps the other, and
the other member is provided with a rib portion configured to receive the one member.

5. The electronic device according to claim 1, wherein
the second attaching member includes a concave groove provided along an edge portion facing the first attaching member in the vicinity of the edge portion.

6. The electronic device according to claim 1, wherein
the attaching member and the attached member are each provided in an elongated shape,
the vicinity of both ends of the attaching member in a longitudinal direction is provided with the one of the second male portion and the second female portion, and
the vicinity of both ends of the attached member in the longitudinal direction is provided with the other of the second male portion and the second female portion.

7. The electronic device according to claim 1, wherein
a fabric member is attached to a flat surface of the first male portion.

8. An electronic keyboard instrument, comprising:
the electronic device according to claim 1; and
a keyboard.

9. A manufacturing method of an electronic device, comprising:
fitting a first male portion protruding in a first direction from an outer circumference of a first attaching member into a first female portion of a second attaching member; and
fitting, into a second female portion included in an attached member, a second male portion provided on either one of the first attaching member and the second attaching member and extending in a second direction different from the first direction, or fitting the second male portion included in the attached member and extending in the second direction different from the first direction into the second female portion provided on either one of the first attaching member and the second attaching member.

10. The manufacturing method of an electronic device according to claim 9, wherein
when the second male portion is fitted into the second female portion, a wall surface sliding portion provided on either one of the first attaching member and the second attaching member comes into contact with a wall included in the attached member.

11. The manufacturing method of an electronic device according to claim 10, wherein
a gap between the first attaching member and the second attaching member is adjusted to be narrower after the wall surface sliding portion comes into contact with the wall than before the wall surface sliding portion comes into contact with the wall.
